(19) United States
(12) Patent Application Publication
(10) Pub. No.: US 2016/0293068 A1
(43) Pub. Date: Oct. 6, 2016

(54) VISUAL COMMUNICATION SIGN AND SYSTEM FOR GENERATING CHARACTERS ON THE SIGN

(71) Applicants: Lia Morin CASTIGLI, FLORIANÓPOLIS-SC (BR); Kiliano HAMES FILHO, SÃO JOSÉ-SC (BR); Quintino Sebastião GONÇALVES, FLORIANÓPOLIS-SC (BR)

(72) Inventors: Lia Morin CASTIGLI, FLORIANÓPOLIS-SC (BR); Kiliano HAMES FILHO, SÃO JOSÉ-SC (BR); Quintino Sebastião GONÇALVES, FLORIANÓPOLIS-SC (BR)

(21) Appl. No.: 15/037,291

(22) PCT Filed: Nov. 17, 2014
(86) PCT No.: PCT/BR2014/050014

§ 371 Date: May 17, 2016

(30) Foreign Application Priority Data
Nov. 18, 2013 (BR) BR1020130296686

(51) Int. Cl. G09F 9/302; G09F 15/00

(52) U.S. Cl. CPC G09F 9/302; G09F 9/3023; G09F 15/0006; G09F 15/0068; G09F 15/0087

(57) ABSTRACT

Visual communication sign and system for generating characters on the sign eliminates the necessity of having in stock and available various numbers or repeated characters, with the formation of characters in advert signs, with multiple functions obtained via sets (2) of pivoting fins (5) arranged over two signboards (1, 8), covered on their back faces by an opaque backboard (4); and the backboard (4) may be replaced by a light box (9) backboard with some sort of internal luminous device.

Refers to the constructive disposition of a visual communication sign and a manual system for forming characters in boards for adverts, with multiple functions and possessing pivoting fins; each set of pivoting fins enables the formation of distinct alphanumerical characters.

Signs, banners, and posters, known and widely used in gas station, sports scoreboards, supermarkets, and others, are formed by boards with characters fixed or printed on them. When there is a need to change the text, the whole set (signs, banners, and posters) has to be replaced. A technological innovation, nowadays a part of the state of the art, consists in utilizing removable characters. This makes it possible for one to replace only the desired or required alphanumerical characters. An example is changing the numbers that indicate the price of fuel at a gas station. There is no need to replace the signboard as a whole. In this model, the alphanumerical characters are put one by one so as to form the numerical value or text desired. There are also signs or banners where the formation of characters occurs by electric/electronic means, such as seven-segment luminous displays arranged in the shape of two adjacent rectangles. The combination of lit segments allows for the visualization of alphanumeric characters. An example is the board indicating the number of the player to be replaced during a soccer match. Documents with similar proposals to the ones mentioned above: CN102350047, CN201744149, CN2505138U, and EP0914843.

The use of boards made of individually removable numbers and characters, where these can be arranged one by one to form the text or numerical value shown on the sign, on gas stations and other places, has the advantage of being resistant and easy to use. However it makes it necessary to have in stock and available various repeated characters or numbers to form the desired number or text. The signs or banners in which the characters are formed via electric/electronic means make use of characters formed by adjacent rectangles with a common side; these have seven segments that form the sides of the rectangles. They present the advantage of better visibility due to the self illumination of the segments, as well as that of allowing the segments to be lit to being programmed, so that they will display the desired characters or numbers. However, they require external power sources; the use of this type of sign or banner in outside environments suffers due to rain and temperature variations, requiring specialized maintenance. And being electronic components, they require special care regarding storage and protection.

VISUAL COMMUNICATION SIGN AND SYSTEM FOR GENERATING CHARACTERS ON THE SIGN, described in this report, comprehends the to configuration of a sign with a graphic visual similar to an electric/electronic display, as mentioned above, that does not use electronic components. It is handled completely manually, with no need for external electric power, and with a visual disposition similar to that of electric/electronic displays. It comprehends a board to which many pivoting fin sets are attached, each set identifying a number or character. Each set of pivoting fin allows the formation of distinct characters. Each pivoting fin set has the graphical representation of two adjacent rectangles with a common side; with seven segments that form the sides of the rectangles. Each segment is made of a pivoting fin that has two faces; one face being the same color of the board, and another face having a color that contrasts with the color of the board. The pivoting fin spins by manual action. The desired alphanumerical character is constructed by the individual spin and positioning of each fin, so as to show the fin faces whose color contrast with the color of the board. When the user desires to change a character, the user spins each pivoting fin 180° over its own axis, showing the desired face. The sets of pivoting fins are arranged in sequence so as to allow for the formation of alphanumerical texts. The system consists of a signboard where the pivoting fin sets are mounted, and a backboard that holds the fin sets in a fixed position, preventing involuntary spin. This allows for, in one same visual communication board, the user being able to form countless combinations of characters, creating numerical values and other adverts. The user simply alters the characters as he or she wishes, regrouping the sets of pivoting fins manually, according to what he or she desires the board to display; be it a numerical value or a text.

The attached drawings and the following detailed descriptions are presented merely as an example, since this object may be created using other known engineering solutions. Therefore, the functional and structural specific details hereby disclosed should not be interpreted as a limitation, but simply as a foundation for the claims; it is a representative basis for an expert in the art of employing and putting into practice the development of the object described in this report to learn from, using as starting point the detailed construction disposition that follows.

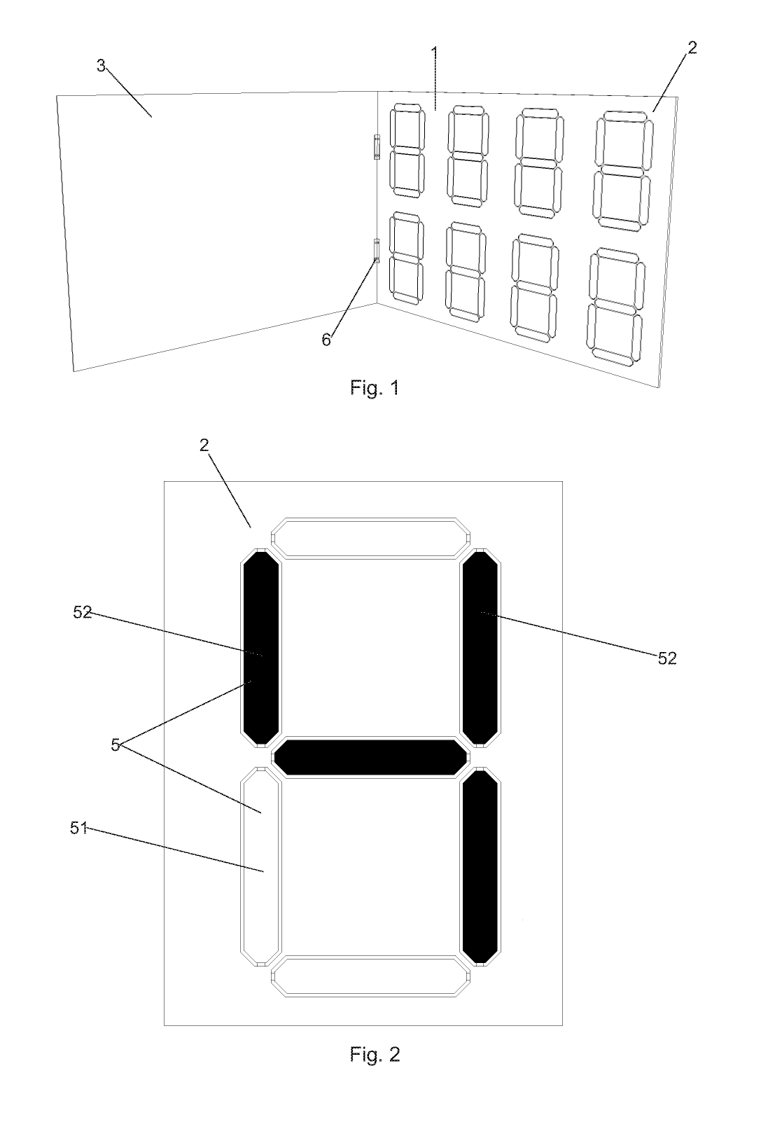

FIG. 1 is a perspective of the signboard (1) with the pivoting fin sets (2) and the backboard (3).

FIG. 2 shows a frontal view of a set (2) of pivoting fins, with the pivoting fins (5) arranged to form the number 4 (four).

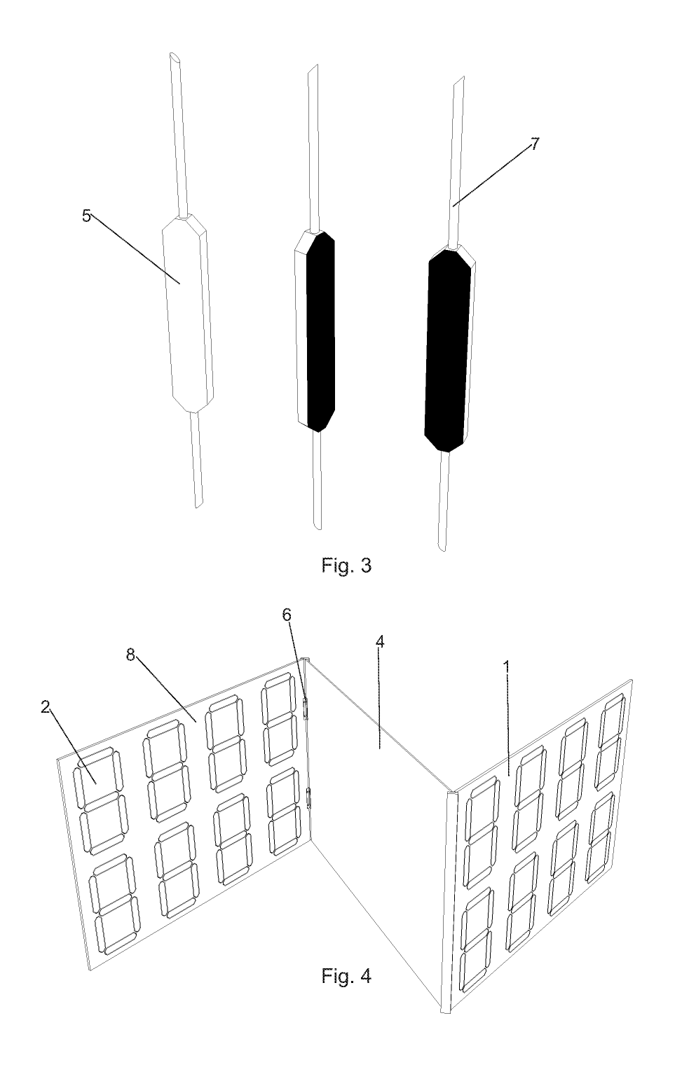

FIG. 3 is a perspective view of the pivoting fins (5), showing its opposing faces of distinct colors and the pins (7) that act as rotation axis for the pivoting fin (5).

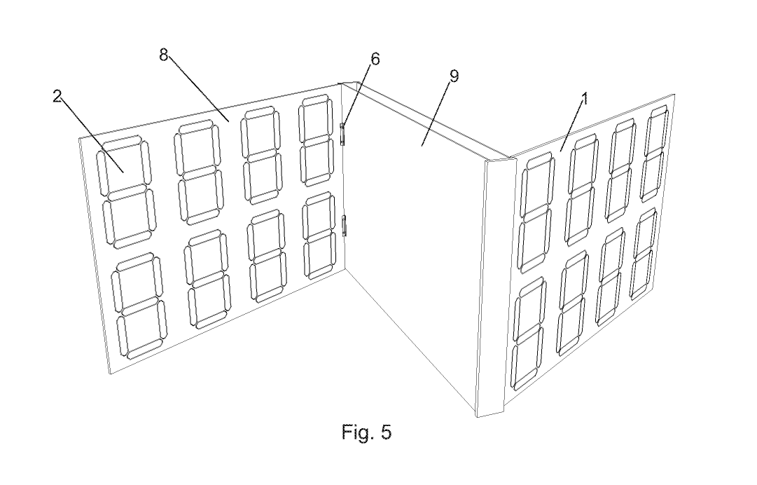

FIG. 4 is a perspective view of a double sided visual communication board, in open position, showing the signboards (1 and 8) with the attached pivoting fin sets (2). Also important are the hinges (6) that unite and articulate each of the signboards (1 and 8) with the backboard (4).

FIG. 5 is a perspective view of a double sided board, showing the light box (9) backboard with some sort of internal luminous device.

The visual communication board comprehends signboards (1) that contain on their surfaces various sets (2) of pivoting fins. They may be aligned to form a logical set of characters, and shown in FIG. 1. Each set (2) of pivoting fins is made of 7 (seven) pivoting fins (5) arranged so as to form the sides of two adjacent rectangles, as shown in FIG. 2. Each pivoting fin (5) has aligned pins (7) that act as the rotating axis of the pivoting fin (5). The pins are pivoted in holes that are present in small tabs attached to the hidden face of the signboard (1). The backboard (3) is attached with hinges (6) to the signboard (1), as shown in FIG. 1.

A variant of the same inventive idea is a double sided visual communication board, shown in FIG. 4 in open position. It has signboards (1 and 8) attached by hinges (6) in opposing corners of the backboard (4).

A second variant of the same inventive idea comprehends the constructive form of the backboard (4). The backboard (4) is replaced by a light box (9) backboard with some sort of internal luminous device, as shown in FIG. 5. The use of a back light associated with the open/closed positioning of the pivoting fins (5) results in a communication board that can be viewed at night.

A third variant of the same inventive idea comprehends the removal of the pivoting fins (5), leaving holes on the signboard (1), in the same position and geometric form used by the pivoting fins (5). These openings are to be covered by a translucent element, such as glass or acrylic. The inventive idea is complemented by the use of an individual back light for each opening. Each back light has an individual, independent on-off switch. Thus, the desired character is obtained by lighting the back light of the openings one wants to emphasize so that they will configure the desired character.

THE SYSTEM FOR GENERATING CHARACTERS ON THE SIGN comprehends the configuration of each set (2) of pivoting fins so as to identify one character per set (2). Thus, as shown in FIG. 2, some pivoting fins (51) with the face that has a color similar to that of the signboard's (1) surface are positioned facing forward, and other pivoting fins (52) are positioned with the color that contrasts with the color of the signboard's (1) surface facing forward. The pivoting fins (52) configure the desired character. In the case of FIG. 2, the desired and configured character is the number “4.”

1-7. (canceled)

8. Visual communication sign and system for generating characters on the sign that comprehends a signboard (1) with a plurality of sets (2) of pivoting fins; and each set (2) of pivoting fins having a graphical representation similar to that of two adjacent rectangles that share a common edge, and having seven segments that form the sides of the rectangles, characterized by the locking of the pivoting fins (5) occur via a backboard (3) that it attached by a hinge (6) to the signboard (1), and the backboard (3) covering the back face of the signboard (1).

9. Visual communication sign and system for generating characters on the sign, according to claim 1, characterized by the visual communication sign being double sided and by it having signboards (1, 8) that are attached by hinges (6) in opposing corners of the backboard (4).

10. Visual communication sign and system for generating characters on the sign according to claim 1, characterized by the opaque backboard (4) being replaced by a light box (9) backboard with some sort of internal luminous device.

11. Visual communication sign and system for generating characters on the sign according to claim 1, characterized by the existing openings of the signboard (1), in the same position and geometrical form utilized by the pivoting fins (5), being covered by a translucent element and having individual back light for each opening, and each individual back light having an independent on-off switch.

12. System for generating characters on the sign describes obtaining characters, contained in claim 2, characterized by comprehending the following stages:
a. determine which characters will be shown sequentially in the communication sign;
b. move away the backboard (3, 4) from the signboard (1, 8) so that the pivoting fins (5) may spin freely;
c. format the first character in the first set (2) of pivoting fins (5) by positioning some pivoting fins (51) with the face that has a color similar to the one of the surface of the signboard (1) to the front, and other pivoting fins (52) to be positioned with the color that contrasts with that of the surface of the signboard (1) to the front, so that the pivoting fins (52) will configure the desired character;
d. repeat the previous operation for the second character and the following ones; and
e. bring closer and attach the backboard (3, 4) to the signboard (1, 8) so that the pivoting fins (5) are unable to spin.
